(19) United States
(12) Patent Application Publication
(10) Pub. No.: US 2008/0128353 A1
(43) Pub. Date: Jun. 5, 2008

(54) Surfactant Combined Flow Through Capacitor

(76) Inventor: Marc D. Andelman, Worcester, MA (US)

Correspondence Address: LESLIE MEYER-LEON, ESQ.;IP LEGAL STRATEGIES GROUP P.C., 1480 FALMOUTH ROAD, P.O. BOX 1210, CENTERVILLE, MA, 02632-1210, US

(21) Appl. No.: 11/794,457

(22) PCT Filed: Jan. 6, 2006
(86) PCT No.: PCT/US06/00278

§ 371 Date: Oct. 17, 2007

Related U.S. Application Data
(60) Provisional application No. 60/642,246, filed on Jan. 6, 2005.

(51) Int. Cl. C02F 1/00; C02F 1/28; C02F 1/32; C02F 1/36

(52) U.S. Cl. 210/632; 210/690

(57) ABSTRACT

Surfactants and flow through capacitors (3) work together synergistically to enhance each other's function. Surfactants added upstream into the feed water (1) enhance the flow through capacitor's (3) ability to purify organic compounds from fluid streams. Surfactants (13) added downstream into the product water enhance the micelle forming processes so that they work more effectively in appliances (11), by working in smaller amounts or concentrations, and with less tendency to precipitate, form a solid or a crud.

### REFERENCE TO PRIOR APPLICATION

This application is based on and claims priority from U.S. provisional patent application Ser. No. 60/642,246, filed Jan. 6, 2005, which is hereby incorporated by reference.

### FIELD OF THE INVENTION

The invention is related to use of a flow through capacitor in combination with a surfactant in order to enhance the removal of organic compounds from a fluid or from a substance suspended therein.

### BACKGROUND OF THE INVENTION

Minerals in hard and total dissolved solids containing water are commonly known to interfere with the utility and operation of surfactants, and therefore, surfactant using appliances, for example, laundry machines, washing machines, showers, baths, and other soap using hardware, including car, truck, and air craft washers, can, bottle, container, and parts washing machines. The minerals ordinarily present in water interfere with micelle formation and surfactant function in micelle forming compounds, surfactants, soaps or detergents needed for optimal function of downstream appliances. The minerals also combine with soaps to create solids which foul and shorten the lifespan and increase maintenance of surfactant using appliances, as well as clinging to clothing, skin, or any other object to be washed in surfactant containing water. In addition to minerals being a problem, the content of minerals varies from region to region and even during different times of day or year in the same place. This makes it difficult to formulate surfactants, particularly for use as detergents, in a uniform way, thereby limiting the options available to less environmentally benign formulations, and using, for example, excessive builders or excessive soap designed for water that can be worse than what the customer has. This in turn leads to requiring more water to rinse that soap, including more hot water, and more energy to heat that water. Therefore, a need exists for a water purification technology that can enhance micelle function by the removal of minerals in a high recovery fashion. High recovery is important so as not to lose the advantage of less water needed to rinse a load of laundry using soap specially formulated for use in flow through capacitor purified water.

### SUMMARY OF THE INVENTION

The invention features a method of enhancing the removal of micelle absorbable compounds from a fluid or from a substance suspended therein, which includes the steps of (a) providing a flow through capacitor; (b) introducing a fluid into the flow-through capacitor and allowing the flow through capacitor to treat the fluid; and (c) prior to, concurrently with, or subsequent to the introducing the fluid to the flow-through capacitor, providing a surfactant and allowing the surfactant to contact the fluid. The fluid can be a water or a water-miscible fluid. Alternatively, the fluid can be a hydrophobic fluid, such as a hydrocarbon. In one embodiment, the fluid can be crude oil or petroleum. Where the fluid is a hydrophobic fluid, the micelles are reverse micelles, and the substances to be removed are polar organic compounds, inorganic compounds, asphaltenes, or non-polar organic compounds.

Where the fluid contains total dissolved solids, the method of the invention further comprises the step of allowing the flow through capacitor to remove at least a portion of the total dissolved solids from the fluid. As used herein, the term “total dissolved solids” refers to the residual particles, e.g., minerals, in a fluid, e.g., water, that remain after evaporation; total dissolved solids are commonly expressed in milligrams per liter (mg/l) or in parts per million (ppm). In one embodiment, where the total dissolved solids are ionic in nature, e.g., are ions, the removal of the total dissolved solids from the fluid produces an at least a partially deionized solution. The partially deionized solution is preferably suitable for use in an appliance used in conjunction with a surfactant.

The method of the invention can be used in or with an appliance that is used to remove substances from a fluid, including without limitation appliances such as washing machines, e.g., a laundry washing machine, a dish washing machine, a shower, a bathtub, a car/truck washing facility, a container washing facility, and a parts washing machine. Where the appliance is used with water, the appliance is preferably of a type whose function benefits from water softening treatments. The flow through capacitor can share parts in common with the appliance, e.g., be an integral part of the appliance system. Alternatively, the flow through capacitor can be a separate component used in tandem with, or in cooperation with, the appliance. By way of example, the flow through capacitor can be used with a laundry or dishwashing machine, or used to fill a basin, tub, or hold up tank.

In one embodiment, the appliance has a control that can select between individually selectable detergents specifically formulated for one or more of colored clothes, white clothes, woolen cloths, delicate clothes, or heavily soiled clothes.

In another embodiment, the surfactant can be provided as a formulation of the surfactant. Preferably, the surfactant formulation is free of a builder. In another preferred embodiment, the formulation is chosen independently of the mineral content of the fluid. In yet another embodiment, the surfactant is provided using an automatic deliver system.

The surfactant can be provided to the fluid upstream of the flow through capacitor. Alternatively, the surfactant contacts the fluid downstream of the flow through capacitor. In one embodiment where the surfactant contacts the fluid subsequent to the introducing the fluid to the flow through capacitor, the method includes the step of mixing the surfactant with the treated fluid. Mixing can be achieved by, e.g., ultrasonic treatment, agitation, or use of a mixing tank.

In one embodiment, the surfactant formulation is provided in a cartridge. Optionally, the surfactant-containing cartridge is used at least a plurality of times to provide the surfactant in contact with the fluid. For example, the cartridge can be used in conjunction with a laundry washing appliance, and the cartridge provides surfactant in contact with the fluid for two or more cycles of use of the appliance.

The flow through capacitor can be operated at above a Nernst potential of 1.2 Volts.

In another embodiment, the method of the invention further includes controlling the conductivity of the fluid.

In another embodiment, the method further includes use of an electrochemical oxidation compound generator. For example, the electrochemical oxidation compound generator can be used to produce bleach, chlorine, or oxidation and reduction compounds from salts present in or added to the water. Alternatively, bleach or enzymes can be independently added to the fluid. In another embodiment, the fluid or a material therein can be exposed or the substance suspended in the fluid to ultraviolet light.

In another embodiment, the method can include allowing the fluid to recycle through the flow through capacitor, for example to include a recycle stream.

In another embodiment, the method can include using a valve to remove waste fluid from the feed stream. The waste fluid can, optionally, include concentrated waste. The waste water can be collected in a tank where appropriate.

Preferably, the surfactant is controlled together with the wash or soak cycle of a laundry machine.

In another embodiment, the surfactant is provided in contact with the fluid prior to introducing the fluid to the flow through capacitor, and the method of the invention further includes allowing the surfactant to become concentrated on a capacitive electrode surface of the flow through capacitor. The surfactant can be desorbed from the capacitive electrode surface by shunting, discharge, or reverse polarity cycles of the capacitor. The micelle absorbable compound can be trapped in a micelle formed from the desorbed surfactant and purified from the fluid.

Alternatively, the micelle absorbable compound can become adsorbed on a capacitive electrode surface of the flow through capacitor. The surfactant can desorb the micelle absorbable compounds from the capacitive electrode surface. The desorbed micelle absorbable compound can be released to a waste stream. Alternatively, the micelle absorbable compound is an organic compound purified from a waste stream. The organic compound can be, e.g., a hydrocarbon, polycyclic, aromatic, halogenated organic, methyl tertiary butyl ether (MTBE), trihalomethane, a pesticide, a steroid, a xenobiotic, or a drug metabolite. The organic compound can be one that is regulated by the Environmental Protection Agency.

Generally, the micelle absorbable compound can be an organic compound, or can be, e.g., a microorganism, e.g., a bacteria, a virus, or a fungus.

The method can further include the step of placing an ion exchange cartridge is downstream of the flow through capacitor. Recoveries and percent purification can be selected by setting high or low limits via a conductivity controller. The surfactant can be automatically metered from a side stream into the fluid. Trace amounts of surfactants can be removed by subsequent carbon absorption, ion exchange, flocculation, microfiltration, or reverse osmosis steps.

In various embodiments of the invention, the surfactant is an anionic, a cationic, a zwitterionic or a non-ionic surfactant. The surfactant can be a co-surfactant, or a mixed surfactant.

### BRIEF DESCRIPTION OF THE DRAWINGS

FIG. 1 is a schematic illustration of one embodiment of the present invention depicting feed water 1, optional prefilter 2, flow through capacitor 3, optional conductivity controller 4, optional three way valve 5, optional post filter 6, an optional component 7 such as a bleach dispenser, ozone or electrochemical oxidation compound generator, optional recycle stream 8, optional pump(s) 9, waste stream(s) 10, appliance 11, control 12, and surfactant cartridge or dispenser 13.

FIG. 2 is a schematic illustration of an embodiment of the invention in which a flow through capacitor is used in conjunction with a soap dispenser, showing feed water 1, flow through capacitor 3, optional two or three way valves 5, waste stream 10, soap cartridge 13, component 14, which is any of an outlet, spray nozzle, a connection to a downstream appliance, a post filter, or a tank, and optional component 15 which is e.g., a collapsible soap or surfactant bladder.

FIG. 3 is a graphic illustration of data showing purification of ionic surfactant with corresponding current (right axis) and voltage (left axis) traces versus time (in seconds).

### DETAILED DESCRIPTION

Surfactants and flow through capacitors work together synergistically to enhance each other's function. Surfactants added upstream into the feed water enhance the flow through capacitor's ability to purify organic compounds from fluid streams. Surfactants added downstream into the product water enhance the micelle forming process so that they work more effectively in appliances, by working in smaller amounts or concentrations, and with less tendency to precipitate, form a solid or a crud.

An advantage of the present invention where the surfactant is added to the feed is the combination of organic removal and total dissolved solids removal in one treatment step or equipment stage. An additional advantage in the case where the surfactant is added to the feed is the combination of organic and total dissolved solids removal together with high recovery

The enhanced micelle flow through capacitor of the present invention can substantially remediate micelle adsorbable compounds, together with total dissolved solids, salts, and inorganic compounds within the same flow stream, thereby simplifying design and eliminating the need to gasket individual flow streams of concentrated and purified solution. The streams of concentrated and purified solution can share the same flow path, and are selectable by a valve which can port the concentrated solution to a waste stream, or a purified solution to product fluid, as determined by a conductivity, optical, or other controller.

An additional advantage of the present invention, whether surfactant is added upstream to the feed or downstream to the product, is that the flow though capacitor can be operated, using one stage, at high purifications and high recoveries simultaneously. It is understood generally that recovery refers to the amount of fluid used and recovered, such that, by way of example, 70% recovery means that only 30% of the fluid goes to the waste stream. It is also generally understood that the degree of purification refers to the concentration of minerals, e.g., salts, in the fluid stream, such that a 70% reduction in mineral concentration is considered a 70% purification. Preferably, the method of the invention achieves, for example, at least 70% recovery and 70% purification, thereby avoiding excessive waste water, or extra purification stages. Therefore, high purification is achieved with little waste water, maintaining the water saving benefits gained by using surfactants in purified water. An additional advantage of the flow through capacitor of the present invention is that the surfactant adding function can be combined within the same piece of equipment, thereby eliminating the need to manually add surfactant in downstream appliances.

Present mineral treating water purification technologies of reverse osmosis and electrodialysis do not lend themselves for use in appliances, either because they have low recovery, have corrodible end electrodes, need an upstream water softener, require excessive maintenance, or are complex to operate. The flow through capacitor of the present invention when combined with surfactants and operated at high recovery, allows the operation of appliances to use less soap, less water to rinse that soap, including less hot water, and less energy to heat the water. A method typically used to allow micelles to function in the presence of these minerals in the water involves the use of “builders”. Builders are various compounds with ion exchange functionality, including polyphosphates, zeolites, and polyelectrolytes, which adsorb minerals in the water. Builders are a known environmental problem. Builders can contribute to sludge or nutrient load, adding to pollution and the cost of municipal treatment. Minerals in the water also interfere with the soap itself, requiring use of more soap, water to rinse the soap, and energy to heat the water, adding further strain upon resources. Therefore, a need exists for a technology to pre-treat water in conjunction with soap and surfactant use in appliances. A further need exists for this water treatment to be high recovery.

The combination of a flow through capacitor with surfactant using appliances of the present invention allows the use of less soap, less water to rinse the soap, including less hot water and commensurate less energy to heat the water.

An embodiment of the present invention is the use of the flow through capacitor at high recoveries, for example, 70% or higher, as a pretreatment to soap using appliances in order to reduce or prevent the use of builders, or upstream water softeners and the added salt required by these. An additional advantage of the present invention is to enable the formulation of surfactants with a uniform chemistry that can be sold in different regions at once. A further embodiment is to enable the formation of soap without builders into compact cartridges, analogous to how ink is sold for ink jet printer cartridges. Because less soap and less builders are required, the soap cartridge can last for more than one laundry cycle, and for an extended period of time, for example, for a week, or a month or more of use. Laundry machines can be specially designed around these cartridges to include a control selected by the operator that can select between surfactants formulated specially for colored clothes, white clothes, delicate clothes, or dirtier clothes.

In an additional embodiment, micelles forming compounds and surfactants can be used in conjunction with flow-through capacitors to extend their use to organic molecules and additional metals. The flow through capacitor offers the additional advantage of total dissolved solids removal, high recovery, and less maintenance due to the fact that current is generated by capacitive charging, rather than the use of corrodible end electrodes.

Further exemplifying the synergy between micelle forming compounds and flow through capacitors of the present invention, is the use of the flow through capacitor for the purification of micelle forming organic molecules per se, for use in surfactant recovery, for purification of micelle forming organic molecules or for removing organic molecules trapped within micelles formed from added surfactant. The method of the invention can be used with a stand alone water appliance, or in combination with other appliances.

Micelles are commonly used to enhance purification of metals and organics via ultrafiltration, for example, as described in Fillipi et al., Use of Micellar-Enhanced Ultrafiltration at Low Surfactant Concentrations and with Anionic-Nonionic Surfactant Mixtures, J. Colloid Interface Sci., 213(1):68-80, May 1, 1999. These same methods can also be used with the flow through capacitor in order to extend or increase its usefulness for the purification, concentration, or removal of organic molecules and metals from aqueous streams, or to combine the added function of organic removal with the total dissolved solids purification ability of the flow through capacitor. The micelle enhanced flow through capacitor can provide an organic removal function as part of a system, or combined with a number of stages of any water purification equipment, including other flow through capacitors, ultraviolet (UV) light, electrochemical methods, reverse osmosis, ultrafiltration, electrodialysis, ion exchange, carbon filtration, microfiltration, and/or adsorbents, where the flow through capacitor is either or both up stream or down stream of other components or appliances in the system.

Examples of the surfactants useful in the invention, including without limitation detergents and soaps, or alone or in combination with other chemicals such as bleaches, builders, enzymes, or co-surfactants, are known to those skilled in the art. See, e.g., Smulders, E., Laundry Detergents, Wiley-VCH Verlag GMBH 2002, pages 7-8 and pages 46-47. Such surfactant can be used in the present invention to mix in either the feed or product stream of the flow through capacitor.

Micelle forming compounds with an overall charge, such as those formed from ionic surfactants, either anionic, cationic, or zwitterionic, can be fed into the feed stream, upstream of the flow through capacitor, where organic and metal contaminants are adsorbed into them. Low molecular weight surfactants of 3000 Daltons or less, for example, less than 500 Daltons can be selected due to their ability to migrate faster in an electric field, thereby increasing flow rate to, for example, one quarter milliliter per minute per gram of carbon electrode or better. Mixed surfactants, for example containing co-surfactants and non ionic surfactants, can be employed in order to form mixed micelles where this optimizes selectivity of the micelle for particular organic or metallic species of interest, thereby enhancing purification of these compounds.

These micelles, when fed with the feed water into flow through capacitor(s) can be concentrated onto the capacitive electrode surfaces and subsequently desorbed into a concentrated waste stream during shunting, discharge or reverse polarity cycles of the capacitor.

Many micelle forming organics, defined here generally as surfactants, adsorb better to carbon once minerals are removed, as described in Nevskaia et al., Surface properties of activated carbons in relation to their ability to adsorb nonylphenol aqueous contaminant, Phys. Chem. Chem. Phys., 2001, 463-468. Therefore, a carbon absorption step subsequent to partial deionization with a flow through capacitor can be employed to enhance organic removal. Organics adsorbed on flow through carbon electrode surfaces, where they can cause fouling, can also be cleaned from the carbon by being desorbed by micelle forming surfactants and released into a waste stream.

Either a charge barrier flow through capacitor, or, where surfactants interfere with the charge barriers, a non charge barrier flow through capacitor be used to remove organics. Flow through capacitors suitable for use in the invention include, for example, those described in U.S. Pat. Nos. 5,192,432, 5,196,115, 5,200,068, 5,360,540, 5,415,768 5,538,611 5,547,581 5,620,597, 5,748,437 5,779,891, 6,325,907 and 6,413,409 (each of which is hereby incorporated by reference). However, if materials of construction interfere with surfactant use, it can be necessary to first passivate or fully adsorb the materials by equilibrating with a solution of either the surfactants used or other hydrocarbons that adsorb to the electrodes used.

Any of the surfactant using appliance applications requires a high instant flow rate. This high instant flow rate adds size and cost to the flow through capacitor. Further embodiments of the present invention can be employed to reduce this size and cost. For example, flow rate can be increased by operating the flow through capacitor at above the Nernst potential of 1.2 Volts when used in combination with an appliance. An additional embodiment of the present invention is to size the capacitor cell such that it provides the desired volume of water within its purification half cycle. This eliminates the need to wait for regeneration, and thereby reduces the need to average the desired flow rate over both the purification and concentration cycles, thereby reducing the size and cost of the flow through capacitor cell needed. In this way, flow rates of over 2 milliliters per minute per gram of carbon, for example over 1 milliliters per minute per gram of carbon or more, can be achieved in order to obtain desired high recoveries and purifications of over 70% each.

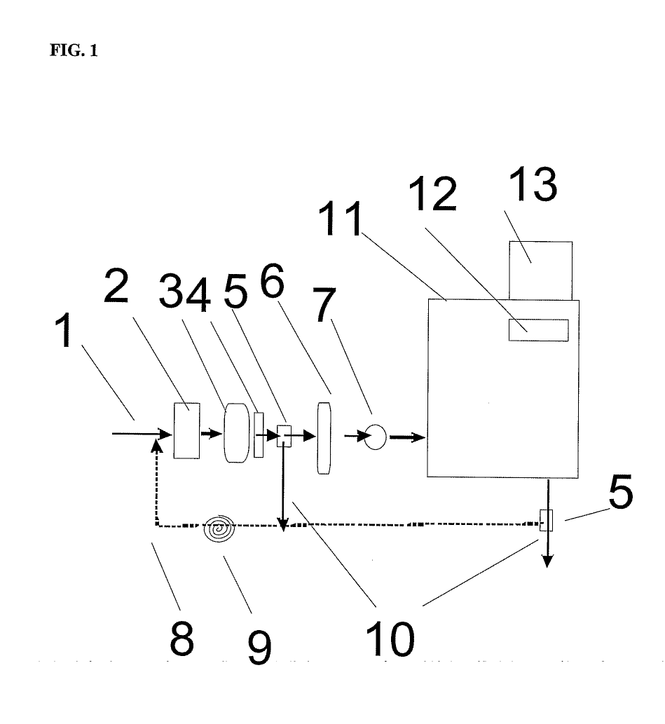

FIG. 1 is a generalized schematic of the present invention, depicting a generalized flow through capacitor deionization system for use with surfactants according to the present invention: (1) feed water; (2) optional prefilter; (3) flow through capacitor; (4) optional conductivity controller; (5) optional three way valve; (6) optional post filter; (7) optional bleach dispenser, ozone, or electrochemical oxidation compound generator; (8) optional recycle stream; (9) optional pump(s); (10) waste stream(s); (11) appliance; (12) control; (13) surfactant cartridge or dispenser.

In the embodiment illustrated in FIG. 1, the feed stream can contain total dissolved solids. Prefiltration can be achieved by fluid filtration methods known to the art, such as without limitation, microfiltration, carbon filtration, ultrafiltration, reverse osmosis. In another embodiment, ultraviolet light can be used to produce oxidation or bleaching compounds and to destroy unwanted germs such as bacterial, fungal, or viral organisms.

The flow through capacitor can be one or more flow through capacitor cells or system thereof known to the art. The flow through capacitor system can optionally share common parts with the appliance, such as valves and power electronics. A preferred embodiment of the present invention is to operate the flow through capacitor at high recoveries of 70% or more when used in combination with laundry washing machines, and other surfactant using appliances, which has the advantage of limiting water usage and increases the economical efficiency of operating the appliance.

The optional conductivity controller is used to set the end points for either or both of the purified fluid product and the waste water product. The recovery can also be automatically determined or set as a function of either or both of these end points. A read out device or method, such as a display, or a computer readable file, can also be included. Software can be included which allows the customer to set purification and recovery from a personal computer.

An optional three way valve is used to port concentrated waste removed from the feed stream. Post filtration can be any water purification step known to the art of water purification. Where this is deionization, it can be used to further reduce total dissolved solids, or to polish water produced by the flow through capacitor.

An optional bleach dispenser or electrochemical oxidation compound generator can serve to kill microbes and to remove stains and dirt, for example, when the invention is used to enhance the removal of dirt or organic compounds from white materials, e.g., white clothing. This can for example be a container of liquid or powder bleach, or oxidation agents, for example halogen or peroxides forming or containing chemicals. In lieu or addition to this, an electrochemical oxidation compound generator can be added to produce bleach, chlorine, peroxides, oxidation or reduction compounds from salts present to or added to the water. An ultraviolet light source can also be used to produce oxidation compounds. An optional recycle stream can be included. In this embodiment, conductivity controller 4 can direct to this stream purified water that is over a specified endpoint, or concentrated water that is under a specified endpoint, back into the feed in order to further purify or further concentrate this water, in order to increase recovery.

An optional pump can be used to pump water through an entire water purification train and downstream appliances.

For treatment of waste water, concentrated contaminant from the flow through capacitor 3 can be discharged to drain, collected in a tank for subsequent disposal or repurification, or fed into a grey water system, or a crystallizer (not shown) for generation of a solid waste.

An appliance for use in conjunction with the flow through capacitor and surfactant of the method of the invention can be a laundry or clothes washing machine, a dish washing machine, a hand held spotless rinse machine, and more generally any fixture or machine that uses or is associated with the use of surfactants or soap, including but not limited to faucets, showers, baths, car washes, or parts washing machines.

Controls can be incorporated in the appliance or system thereof and can be used to select different preformulated surfactants or soaps for use with different varieties of clothing, including whites, colored, delicates, woolens, extra dirty, or less dirty. Controls are also used to select between waste solutions and purified solutions. The controls can be, without limitation, optical controls or conductivity controls. An optional valve can also be used to control the amount and timing of surfactant, for example, when coordinating with the wash or soak cycle of a laundry or other type of washing machine.

The surfactant dispensing system can include one or more of a cartridge, container, or vessel similar to that used to store ink for use in ink jet printers. This cartridge can optionally have one or more subcontainers holding different formulations of surfactants selectable by controls. This can also be separate containers with individually selectable surfactant formulations. A fluid dispensing system can be used analogous to that used to dispense liquids, powders, or obtain fluid extracts from substances contained in cartridges, for example, employing components or combinations of components described but not limited to the following patents: U.S. Pat. No. 6,007,190, U.S. Pat. No. 4,623,905, U.S. Pat. No. 3,785,568, JP2004239844A2, EA0004492B1 (WO99/46126), U.S. Pat. No. 5,129,789, U.S. Pat. No. 6,293,255, EP1419886A1, and U.S. Pat. No. 5,656,316 (each of which is hereby incorporated by reference).

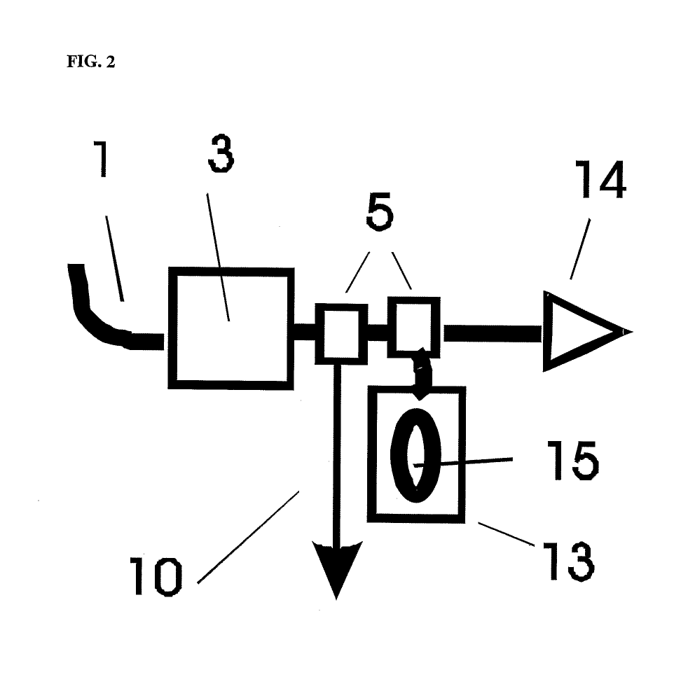

FIG. 2 is a schematic of a flow through capacitor with soap dispenser: (1) feed water 1, containing salts or total dissolved solids; flow through capacitor 3, which is used to partly deionize feed water; optional two or three way valves 5 to select between waste and product water, or to allow soap into the product water stream; waste stream 10; soap cartridge 13, which can be also be, e.g., a surfactant bladder to contain soap or other micelle forming compound. A component (14) can be an outlet, spray nozzle, or connection to down stream appliance, post filter, or tank, to spray, dispense product water or soap and water mixture, or to connect to a laundry washing machine, dish washing machine, car wash system, or other soap using appliance; (15) optional collapsible soap or surfactant bladder. FIG. 2 depicts a flow through capacitor with built in soap addition combined together with the flow through capacitor according to the present invention. Liquid surfactant or soap is contained in a collapsible bladder 15 within a cartridge 13. Product water flowing past this bladder creates a vacuum which pulls quantities of a surfactant into the product water stream. An optional valve can be used to control amount and timing of the surfactant, for example, when coordinating with the wash or soak cycle of a laundry machine.

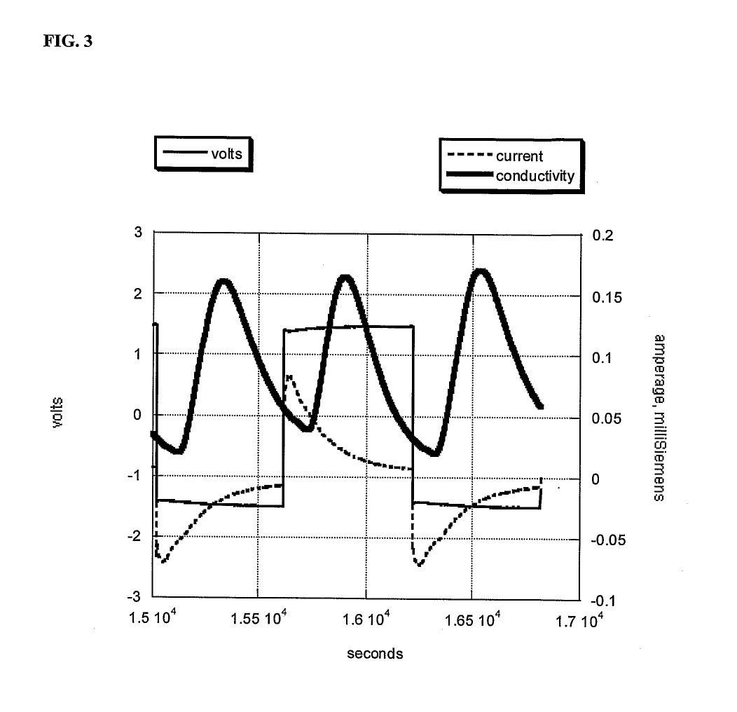

FIG. 3 is a graph of experimental data showing purification of ionic surfactant with corresponding current and voltage traces versus time. The data is FIG. 3 was obtained using Labview™ (National Instruments Corporation, Austin, Tex.). Conductivity data is in milliSiemens. Amperage and voltage are recorded and graphed versus time, as described in Example 3, below.

### EXAMPLE 1

One thousand milligrams per liter of sodium laurel sulfate (Sigma-Aldrich Corporation, St. Louis, Mo.) was added to 1 liter of tap water containing over 10 parts per million, in this case, 160 parts per million of total dissolved solids. This was fed into a flow through capacitor made from facing layers of activated carbon electrode and a flow spacer at a flow rate of at least 1 milliliter per minute per gram of carbon electrode material. Voltage of 1 volt or more was applied in alternating cycles of voltage, shunt, and reverse polarity of 100 seconds or more. Purified water was collected. The feed water in the purified sample had been purified of surfactants and any organics present in the tap water which has partitioned or adsorbed into the micelles to a degree of fifty percent or more.

### EXAMPLE 2

A flow through capacitor is built into a washing machine to reduce the concentration of salts in the feed water by 70% or more with 70% recovery or more. Water was purified at greater than 70% as compared to the feed concentration of total dissolved solids. The capacitor can be sized in order to produce purified water at the flow rate required to supply any of the various washing machine cycles, including fill and rinse. Alternatively, a smaller flow through capacitor can be used to fill a tank or the basin of the washing machine itself when the washing machine is not otherwise being used. A bladder, pressurized, or atmospheric tank or washing machine basin can also be filled prior to purification, by flowing quickly through the flow through capacitor in either on or off mode, or shunting around it. This pre-filled water can then be purified by the flow through capacitor in a batch mode prior to filling a laundry or dishwashing machine, or other appliance, or prior to adding laundry to a basin or tub of purified water in a washing machine. A hold up tank, either pressurized, bladder, or atmospheric, can be used to provide the instant flow desired for one or more consecutive loads of laundry. Disposable soap cartridges are removeably inserted into a dock, bay, connector, or snap fitting built into the washing machine. Alternatively, soap reservoirs can be built into the machine designed to be occasionally refilled by the customer. A control means selectable by the operator selects one or more soap cartridge(s) or soap reservoir(s) individually, or in combination, to be used with, for example, whites, colored, stains, oil and grease, relatively clean, woolens, delicates, or cottons. An optional bleach dispenser or electrochemical chlorinator or oxidation compound generator supplies bleaching or antimicrobial agents. Soaps and bleaches work more effectively in the partially deionized water supplied to the washing machine by the flow through capacitor, thereby allowing the use, if desired, of less soaps and bleaching chemicals, less water, less hot water, and less energy to heat that water.

### EXAMPLE 3

A solution of greater than 1 part per million, for example, 1000 parts per million of an ionic surfactant, in this case, cetylpyridinium bromide (Sigma-Aldrich Corporation, St. Louis, Mo.; catalogue number C-5881) is fed through a flow through capacitor at a flow rate of 0.10 milliliters per minute per gram of electrode material or higher, for example 0.25 ml/minute per gram or higher. The flow cell used was a standard non charge barrier flow through capacitor cell using facing layers of activated carbon electrode and a flow spacer. Voltage of 1.5 Volts was applied from the power source. Voltage cycles where up to 600 seconds at voltage, up to 600 seconds at shunt, and up to 600 seconds at reverse polarity. The conductivity of the surfactant solution changed upon the application of voltage in either polarity. Data is as shown in FIG. 3 above. Feed conductivity was 0.1 milliSiemens or higher. Any portion of fluid recovered downstream of the capacitor with a conductivity lower than the feed is considered purified, and can be saved aside as product, can be recycled into the feed again for further purification or can be fed into downstream purification stages for further purification. Any portion of fluid recovered downstream of the capacitor with a conductivity higher than the feed is considered concentrated, and can be disposed of, saved aside as a recovered product, feed into downstream purification stages for recovery or purification, or fed back into the feed for further concentration. This concentrated waste can also be disposed of along with organics originally present in the feed water that adsorb into the micelles and are concentrated and discharged from the flow through capacitor along with the concentrated surfactants forming the micelles. Any organics, metals or other compounds that partition, concentrate, or adsorb into micelles can be removed from a fluid stream this way. Where reverse micelles are used, the fluid stream itself can be organic, such as petroleum, crude oil, or hydrocarbons and fractions thereof, and the contaminants removed can be other organics, polar organics, or inorganics such as salts removed from hydrocarbons. Purified product or concentrated waste can optionally be selected by sensing the optical density of the solution and controlling a valve via a voltage or amperage signal to select for waste or product streams.

A disposable ion exchange cartridge is placed downstream of a flow through capacitor and before a washing machine, dish machine, a car washing system, or any other soap using appliance including faucets, showers or baths. The ion exchange is used to polish the water purified by the flow through capacitor. The combination of an ion exchange downstream of a flow through capacitor allows operation of the flow through capacitor at a size and cost reducing flow rate of one or more milliliters per minute per gram of electrode material, while at the same time allowing high total purification of at least 70% or more, for example, 80% or 90% or more. Recoveries and percent purification can be selected by setting high and low limits via a conductivity controller that reads the conductivity of the water coming out of the flow through capacitor cell. If a lower set point is reached, a valve selects a product stream whereupon purified water is released. If the conductivity is above a set point, the water can be re-circulated, via a valve back into the feed, or, a discharge cycle is initiated. Upon discharge, the conductivity controller can be used to actuate a waste valve in order to release water that is above a high set point. In this way, by setting both high and low conductivity limits for waste and purified water respectively, percent recovery is automatically adjusted as well. Control readouts or inputs can be designed around this fact to allow the customer to select for percent purification and or recovery. The purified water so produced is mixed with soap and used to wash cloths, machine parts, dishes, or for personal hygiene. Due to the fact that minerals have been removed by the flow through capacitor from the water, detergents and soap can be formulated without added “builders”. Because less soap is required where purified water is used, special long lasting soap cartridges can be designed to fit into appliances such as laundry, dish machines, car wash systems, or even shower heads.

### EXAMPLE 4

A hand held flow through capacitor with feed water provided from a garden hose is used to produce deionized water for spotless rinsing of cars, vehicles, or air craft. Optional soap pellets, or, dispensing cartridges, for example, such as that shown in FIG. 2, can be attached between the capacitor and the hose in order to deliver amounts of soap when desired. A proportioning valve or metering pump can optionally be included to deliver a desired aliquot of surfactant.

### EXAMPLE 5

Ionic surfactants are added to crude oil or a refinery fraction and agitated to form reverse micelles. The micelles attract salts, asphaltenes, or other undesirable compounds. Upon being fed through a flow through capacitor, the micelles are adsorbed and discharged as a concentrated waste.

### EXAMPLE 6

An organic contaminated feed stream is connected between a flow through capacitor and a delivery point for surfactants, such as a side stream with or without a valve connected with a osmotic, peristaltic, valve, or other delivery means connected for automated delivery or metering of surfactants. Downstream of the delivery point there can optionally be included a mixing means can be employed, such as a cyclone, an ultrasonic sound source, tank, or agitator. The organics present in the feed stream to be removed from the product water by the present invention can include any organic molecule present in water including hydrocarbons, polycyclics, aromatics, halogenated organics, EPA regulated or unregulated contaminant including methyl tertiary butyl ether (MTBE), trihalomethanes, pesticides, herbicides, steroids, xenobiotics and drug metabolites. Concentrations of contaminants to be removed can be in parts per trillion, billion, million, thousand, or hundred or more. While this method is described in general for atomic and molecular compounds, it should be understood that, were viruses or microorganisms partition into a micelle at higher concentration than normally present in the feed, this technique is also applicable. Chlorine and Hydrogen sulfide can also be removed by this method. Where trace amounts of surfactants are objectionable in product water, it can be desirable to remove these by subsequent carbon absoption, ion exchange, oxidation, flocculation followed by micro or ultrafiltration or reverse osmosis, or other steps.

### EXAMPLE 7

Organics may also be purified from a feed stream via a two step process of surfactant absorption onto capacitive electrodes, followed by introduction of an organic contaminated feed stream in order to concentrate the organics onto the surfactant absorbed electrode surface, followed by release of the surfactants micelles with absorbed organics. Where the surfactants used are ionic, they may be electrostatically absorbed onto a charged capacitive electrode surface. The release of said micelles occurs upon shunt, reverse polarity, discharge, or reversing the direction of current flow, thereby forming an organic concentrated waste stream selected by a valve. Fresh surfactants are electrostatically absorbed onto the capacitive electrodes in order to provide a fresh surface for organic absorption. The advantage of this two step approach is that the organic contaminants are purified from the feed stream by absorption onto the surfactants already present on the electrode surface. This absorption process is faster than an electrophoretic process where organics and micelles are removed from a feed stream together in one step.

Surfactants used above may be ionic surfactants, either anionic, zwittterionic, cationic, or surfactant mixtures that may also include enzymes, proteins, polyelectroltes, etc. Typically, voltages between 0.3 Volts and 3 volts are used to absorb ionic surfactants onto the flow through capacitor electrodes, preferably 1 to 2 volts to avoid electrolysis reactions that would destroy the surfactants, unless it is desired to use high-voltage to destroy, or to chemically alter so as to cause desorption of surfactants and any absorbed organics. Higher voltages over 1.2 volts also provide faster electrophoresis of larger molecular weight molecules and micelles, for example, over 100,000 Daltons.

1. A method of enhancing the removal of micelle absorbable compounds from a fluid or from a substance suspended therein, comprising:
(a) providing a flow through capacitor;
(b) introducing a fluid into said flow-through capacitor and allowing said flow through capacitor to treat said fluid; and
(c) prior to, concurrently with, or subsequent to said introducing said fluid to said flow-through capacitor, providing a surfactant and allowing said surfactant to contact said fluid.

2. The method of claim 1, wherein said fluid is water.

3. The method of claim 1, wherein said fluid is a hydrocarbon, crude oil, or petroleum.

4. The method of claim 3, wherein said micelles are reverse micelles, and the substances to be removed are polar organic compounds, inorganic compounds, asphaltenes, or non-polar organic compounds.

5. The method of any one of claims 1, 2, 3, or 4, wherein the fluid contains total dissolved solids and said method comprises the step of allowing said flow through capacitor to remove at least a portion of said total dissolved solids from said fluid.

6. The method of claim 5, wherein said total dissolved solids comprises ions, and the removal of said total dissolved solids from said fluid produces an at least partially deionized solution.

7. The method of claim 6, wherein said partially deionized solution is suitable for use in an appliance used in conjunction with a surfactant.

8. The method of claim 7, wherein said appliance is selected from a group consisting of a laundry machines, a dish washing machine, a shower, a bathtub, a car/truck washing facility, a container washing facility, and a parts washing machine.

9. The method of claim 8, wherein said flow through capacitor is operated at or above 70% recovery.

10. The method of claim 8, wherein the flow through capacitor is operated at least 70% purification.

11. The method of claim 5, wherein the appliance has a control that can select between individually selectable detergents specifically formulated for one or more of colored clothes, white clothes, woolen cloths, delicate clothes, or heavily soiled clothes.

12. The method of claim 5, wherein the flow through capacitor shares parts in common with the appliance.

13. The method of claim 5, wherein the flow through capacitor is used with a laundry or dishwashing machine and used to fill a basin, tub, or hold up tank.

14. The method of claim 1, wherein providing said surfactant comprises providing a formulation of said surfactant.

15. The method of claim 14, wherein said providing and contacting step comprises using automated delivery means of contacting said fluid with said surfactant.

16. The method of claim 14, wherein said formulation is free of a builder.

17. The method of claim 14, wherein said formulation is chosen independently of the mineral content of said fluid.

18. The method of claim 1, wherein said surfactant contacts said fluid downstream of the flow through capacitor.

19. The method of any one of claim 1 and claim 2, wherein said surfactant contacts said fluid subsequent to said introducing said fluid to said flow through capacitor, and further comprising the step of mixing said surfactant with said treated fluid.

20. The method of claim 19, wherein said mixing comprises ultrasonic treatment.

21. The method of claim 19, wherein said mixing comprising agitation.

22. The method of claim 19, wherein said mixing comprises using a mixing tank.

23. The method of claim 14, wherein said surfactant formulation is provided in a cartridge.

24. The method of claim 23, wherein said surfactant-containing cartridge is used at least a plurality of times to provide said surfactant in contact with said fluid.

25. The method of claim 14, wherein said cartridge is used in conjunction with a laundry washing appliance, and said cartridge provides surfactant in contact with said fluid for two or more cycles of use of said appliance.

26. The method of claim 1, wherein the flow through capacitor is operated at above a Nernst potential of 1.2 Volts.

27. The method of claim 1, wherein said method further comprises controlling the conductivity of said fluid.

28. The method of claim 1, wherein said method further comprises use of an electrochemical oxidation compound generator.

29. The method of claim 28, wherein the electrochemical oxidation compound generator produces bleach, chlorine, or oxidation and reduction compounds from salts present in or added to the water.

30. The method of claim 1, further comprises introducing bleach to said fluid.

31. The method of claim 1, further comprising exposing said fluid or said substance suspended in said fluid, to ultraviolet light.

32. The method of claim 1, further comprising the step of allowing said fluid to recycle through said flow through capacitor.

33. The method of claim 1, further comprising the step of using a valve to remove waste fluid from the feed stream.

34. The method of claim 33, wherein the waste fluid comprises concentrated waste.

35. The method of claim 34, further comprising collecting said waste water in a tank.

36. The method of claim 15, wherein the surfactant is controlled together with the wash or soak cycle of a laundry machine.

37. The method of claim 1, wherein said surfactant is provided in contact with said fluid prior to introducing said fluid to said flow through capacitor, and wherein said method further comprises allowing said surfactant to become concentrated on a capacitive electrode surface of said flow through capacitor.

38. The method of claim 37, wherein the surfactant is desorbed from said capacitive electrode surface by shunting, discharge, or reverse polarity cycles of the capacitor.

39. The method of claim 38, wherein said micelle absorbable compound is trapped in a micelle formed from said desorbed surfactant and purified from said fluid.

40. The method of claim 37, wherein said method further comprises allowing said micelle absorbable compound to become adsorbed on a capacitive electrode surface of said flow through capacitor.

41. The method of claim 40, further comprising allowing said surfactant to desorb said micelle absorbable compounds from said capacitive electrode surface.

42. The method of claim 41, further comprising the step of allowing said desorbed micelle absorbable compound to be released to a waste stream.

43. The method of claim 40, wherein micelle absorbable compound is an organic compound purified from a waste stream.

44. The method of claim 43, wherein said organic compound is selected from the group consisting of hydrocarbons, polycyclics, aromatics, halogenated organics, methyl tertiary butyl ether, trihalomethane, pesticides, steroids, xenobiotics, drug metabolites.

45. The method of claim 43, wherein said organic compound is a compound regulated by the Environmental Protection Agency.

46. The method of claim 40, wherein said micelle absorbable compound is an organic compound.

47. The method of claim 40, wherein said micelle absorbable compound is a micro-organism.

48. The method of claim 1, further comprising placing an ion exchange cartridge is downstream of the flow through capacitor.

49. The method of claim 1, wherein recoveries and percent purification is selected by setting high or low limits via a conductivity controller.

50. The method of claim 1, wherein surfactant is automatically metered from a side stream into said fluid.

51. The method of claim 1, wherein trace amounts of surfactants are removed by subsequent carbon absorption, ion exchange, flocculation, microfiltration, or reverse osmosis steps.

52. The method of claim 1, wherein said surfactant is an anionic, a cationic, a zwitterionic or a non-ionic surfactant.

53. The method of claim 1, wherein said surfactant is a co-surfactant.

54. The method of claim 1, wherein said surfactant is a mixed surfactant.

55. The method of claim 1, further comprising introducing an enzyme to said fluid.
